(19) United States
(12) Patent Application Publication
(10) Pub. No.: US 2009/0226603 A1
(43) Pub. Date: Sep. 10, 2009

(54) Pressure extrusion method for filling features in the fabrication of electronic devices

(75) Inventor: Tyler Lowrey, Rochester Hills, MI (US)

Correspondence Address: Ovonyx, Inc, 2956 Waterview Drive, Rochester Hills, MI, 48309, US

(73) Assignee: Ovonyx, Inc.

(21) Appl. No.: 12/075,222

(22) Filed: Mar. 10, 2008

(51) Int. Cl. B05D 5/00

(52) U.S. Cl. 427/58

(57) ABSTRACT

A method of filling high aspect ratio features with active electronic or conductive materials. In one method, high pressure extrusion is used to urge the as-deposited active or conductive material into an incompletely filled opening. In another method, a rapid thermal anneal process is used to induce reflow of the as-deposited active or conductive material into an incompletely filled opening. Both methods are also effective in densifying active or conductive materials within openings by collapsing voids that arise in the as-deposited state. The instant methods provide for more uniform and consistent filling of openings and minimize the variability and impairment of electrical characteristics of active material devices. Active materials include phase-change materials, chalcogenide materials, switching materials, and programmable resistance materials.

### FIELD OF INVENTION

This invention relates generally to the filling of openings and other features with an active material during fabrication of electronic devices. More particularly, this invention relates to the uniform filling of openings and other features with programmable resistance or electronic switching materials. Most particularly, this invention relates to the uniform and complete filling of openings and features with phase change, chalcogenide, or switching materials via extrusion induced by high gas pressure.

### BACKGROUND OF THE INVENTION

Programmable resistance materials and fast switching materials are two classes of promising active materials for next-generation electronic storage, computing and signal transfer devices. A programmable resistance material possesses two or more states that differ in electrical resistance. The material can be programmed back and forth between the states by providing energy to the material to induce an internal transformation of the material that manifests itself as a change in resistance of the material. The different resistance states can be used to store or process data and the different resistance values of the resistance states can serve as identifying indicia of the states.

Fast switching materials are capable of being switched between a relatively resistive state and a relatively conductive state. Application of an energy signal, typically an electrical energy signal, induces the change from the relatively resistive state to the relatively conductive state. The relatively conductive state persists for so long as a certain level of energy signal continues to be applied. Once the energy signal is removed, the switching material relaxes back to its quiescent resistive state. Devices that incorporate switching materials are useful as voltage clamping devices, surge suppression devices, signal routing devices, and access devices.

Phase change materials are a promising class of programmable resistance materials. A phase change material is a material that is capable of undergoing a transformation, frequently reversible, between two or more distinct structural states. In a common embodiment, a phase change material is reversibly transformable between a crystalline state and an amorphous state. In the crystalline state, the phase change material has low resistivity; while in the amorphous state, it has high resistivity. The distinct structural states of a phase change material may be distinguished on the basis of, for example, crystal structure, atomic arrangement, order or disorder, fractional crystallinity, relative proportions of two or more different structural states, a physical (e.g. electrical, optical, magnetic, mechanical) or chemical property etc. Reversibility of the transformations between structural states permits reuse of the material over multiple cycles of operation.

Typically, a programmable resistance material or switching device is formed by placing an active material, such as a phase change material or switching material, between two electrodes. Operation of the device is effected by providing an electrical signal between the two electrodes and across the active material. Programmable resistance materials may be used as the active material of a memory device. Read and write (or programming) operations in a memory device are performed by providing current or voltage signals across the two electrodes. Read operations normally entail measuring the resistance of the active memory material and write operations normally entail applying current pulses of selected current and duration. The transformation between the relative resistive state and relatively conductive state of a switching material may similarly be induced by providing a current or voltage signal between two electrodes in contact with the switching material. Typically, a signal having a voltage exceeding a threshold voltage is applied to effect the switching transformation.

One of the significant practical challenges faced by programmable resistance memory and switching devices is a desire to reduce the contact area of the active material with one or more electrodes that contact the active material. By reducing the contact area, the energy required to program a memory device or switch a switching device can be reduced and more efficient devices can be achieved.

Fabrication of electronic devices, including logic, processing, and memory devices, typically requires processing steps that include deposition of one or more layers, forming features or openings in some of the layers, and filling features with particular materials.

Deposition of the various layers in active material devices is typically accomplished using methods such as physical (PVD) or chemical (CVD) vapor deposition, atomic layer deposition (ALD), evaporation, solution phase deposition, and selective deposition. These methods generally involve the reaction, decomposition, and/or ionization of gaseous, liquid or solid precursors.

Lithography is a process commonly used in the formation of electronic devices to form openings and features. Lithography involves transferring a pattern to a resist arranged on a surface of a semiconductor wafer. Typically a resist material is formed over the surface and patterned to form a mask. Portions of the structure underlying the unmasked portions of the surface are then removed by a chemical or physical process. Lithography is commonly used to define small-scale features of semiconductor and other active material devices and often sets a limit on the goal of device miniaturization.

Other common fabrication steps include chemical-mechanical polishing, etching, deposition, ion implantation, plating, and cleaning. Individual devices are significantly smaller than the base wafer or substrate, and an array of devices is normally formed. After processing is complete, the wafer may be separated into individual devices or groups of devices.

In electronic device fabrication, it is desirable to reduce the length scale or feature size of devices as much as possible so that a larger number of devices can be formed on a given substrate area. As the feature size of devices is minimized, however, processing of the devices becomes more difficult. Small scale features become more difficult to define as the lithographic limit of resolution is reached and features that are defined become more difficult to process.

A common step in processing involves depositing a layer and forming an opening in it. Openings such as channels, trenches, holes, vias, pores or depressions in layers are commonly employed to permit interconnections between devices or layers of a structure. Typically, the opening is formed by lithography or etching and is subsequently filled with another material. As the dimension or length scale of an opening decreases, it becomes increasingly difficult to satisfactorily fill the opening with another material.

Techniques such as physical vapor deposition (PVD) or sputtering fail to provide dense or complete filling of openings when the dimensions of the opening are reduced below a critical size. Instead of providing a dense, uniform filling, these techniques increasingly incompletely fill openings as the aspect ratio (ratio of feature depth to feature lateral dimension) of the opening increases. The deposited layer of material includes gaps, pores, voids, or other unfilled regions. The packing density of material formed in the opening may vary in the depth or lateral dimensions of the opening.

Lack of structural uniformity in the filling of openings compromises device performance due to both variations across the devices of an array and less than optimal performance from individual devices due to the defective nature of the deposited material. Imperfections in filling openings become especially pronounced as the aspect ratio of the opening increases. Deep, narrow channels, for example, are more difficult to uniformly fill than channels that are shallow and wide. With deep, narrow features, sputtering and other physical deposition techniques are oftentimes unable to deliver material uniformly throughout the depth of the feature. Delivery of material, for example, to the bottom of a high aspect ratio feature becomes difficult. Dense or complete filling of a high aspect ratio feature also becomes difficult because of the tendency for material to aggregate at or near the top of the feature during deposition. Aggregation of material in the upper part of the feature occludes the lower part of the feature, thus preventing access of the depositing species to the lower parts of the feature.

In the fabrication of active material devices, including non-volatile memory, programmable resistance memory and electronic switching devices, it is desirable to have completely and evenly filled openings. In many active material devices, the bottom of the opening is adjacent to the lower contact and the top of the opening is adjacent to the top contact or electrode. Incomplete or non-uniform filling of the opening with the active material can lead to uncontrolled thickness variation of the active material as well as gaps or voids within the opening that can lead to device shunting, premature device failure or poor device characteristics.

Conformality of deposition is another processing difficulty that becomes exacerbated as feature size decreases. Fabrication of semiconductor devices generally involves forming a stack of layers, where the individual layers may differ in dimensions (lateral to or normal to the substrate) and compositions. The process of fabricating a semiconductor device generally involves sequential deposition of one layer upon a lower (previously formed) layer. Device performance often improves when layers are formed conformally on the immediately underlying layer. Conformality occurs when a deposited layer conforms to the shape and contours of the underlying layer. Smooth, dense, and uniform coverage is desired. In addition to difficulties with achieving uniform filling, openings also present complications for achieving conformal deposition that become more pronounced as the aspect ratio of the opening increases.

When fabricating semiconductor devices, it is often necessary to first form an underlying layer with an opening and then to deposit a subsequent layer over opening. Conformality requires that the subsequent layer faithfully conform to the shape and texture of the underlying layer, including the opening. The boundary or perimeter of an opening is frequently defined by an edge, step, or other relatively discontinuous feature. The shape of an opening is generally defined by a sidewall or perimeter boundary and a lower surface or bottom boundary. A trench opening, for example, is defined by generally vertical sidewalls and a bottom surface that is generally parallel to the substrate. Conformality over an opening requires uniform coverage of the edges or steps that form the boundary of the opening as well as its sidewall surfaces. Conformality can be better achieved over low aspect ratio openings and may be facilitated by forming openings with sloped sidewalls. Achieving conformality over openings becomes increasingly difficult, however, as the feature size of the opening decreases or the aspect ratio of the opening increases and/or the walls are made more vertical.

High aspect ratio electrical contacts represent an important approach to reducing the programming currents of programmable resistance and switching devices and for reducing the required device area. The fabrication of these devices often includes a step of forming an opening in a dielectric layer, filling the opening with an active programmable resistance material (such as a programmable resistance material or fast switching material), and then including a conductive material over the contact. Since the programming energy scales with the cross-sectional area of contact, it is desirable to form contacts with small lateral dimensions. Accordingly, it is desirable to develop techniques for forming and filling openings having small lateral dimensions or high aspect ratios without compromising performance due to lack of conformality or imperfections in filling. At the same time, however, it is desirable to continue to use well-established deposition techniques (e.g. physical vapor deposition) to form contacts due to their maturity, simplicity and reliability. The instant invention addresses these needs by providing a method that facilitates dense, uniform, and/or conformal filling of high aspect ratio features.

FIG. 1 depicts a representative structure of an active material device that illustrates the nature of imperfections that may form in an opening of the electrical device when an active material layer is deposited via a deposition process such as physical vapor deposition. A conductive bottom electrode layer 106 is formed over a substrate 102. An insulative layer 110 having an opening 128 formed therein with sidewalls 120 is then formed over the conductive bottom electrode layer 106. Active material layer 114 is deposited over the insulative layer 110 in the opening 128 of insulative layer 110 using a sputtering or physical vapor deposition process. The active material layer 114 includes imperfections in the form of non-uniform thickness and/or non-conformal region 112 within the opening 128. The imperfections impair device performance and reliability. The prevalence of the imperfections increases as the aspect ratio of the opening increases.

FIG. 2 depicts another representative structure 130 of an active material device that illustrates the nature of imperfections that may form in an opening of the electrical device when an active material layer is deposited non-conformally. A conductive bottom electrode layer 134 is formed over a substrate 132. An insulative layer 136 having an opening 140 formed therein with tapered or sloped sidewalls 138 is then formed over conductive bottom electrode layer 134. Active material layer 142 is deposited over the insulative layer 136 in the opening 140 of insulative layer 136 using a sputtering or physical vapor deposition process. The active material layer 142 includes imperfections in the form of regions such as 146, which may have non-uniform thickness and/or non-conformal features. While coverage of the active material layer 142 for the device 130 with the sloped sidewalls is slightly better than the active material layer 114 of the device 100, the imperfections detract from device performance and reliability. The prevalence of the imperfections increases as aspect ratio of the opening increases.

FIGS. 1-2 illustrate that openings and small scale features in general are difficult to fill using techniques such as physical vapor deposition. The primary cause of degraded quality of films deposited by physical vapor deposition is the line-of-sight nature of the technique. Matter ejected from a sputtering target is transported in a straight line trajectory to the deposition surface. As the deposition proceeds, aggregates of ejected matter accumulate at the deposition surface in a random fashion. Matter that deposits at the growth front of the layer acts to block access to the interior parts of the layer. As a result, imperfections or irregularities created in the interior of the layer during deposition are not ameliorated and become an integral part of the final layer. This complication is common to line-of-sight deposition techniques and becomes more serious as the lateral dimensions of an opening decrease or the aspect ratio of the opening increases.

Chemical vapor deposition (CVD) (including variants such as metalorganic chemical vapor deposition (MOCVD) and plasma-enhanced chemical vapor deposition (PECVD)) is one method available in the prior art for filling openings that can potentially remain effective as the lateral feature size of the opening decreases. The molecular dimensions of the gas phase precursors used in CVD allow the precursors to enter small dimensional openings, where they subsequently react at a bottom or sidewall surface of the opening to a relatively uniform layer. Although CVD in principle is a viable strategy for filling lithographic or sublithographic openings in programmable resistance and switching devices, the technique is limited in practice because of the unavailability of appropriate gas phase precursors that react in concert at desired temperatures, for a variety of active material or electrical contact compositions desirable for programmable resistance, fast switching, and other electronic devices. In addition, the reaction conditions (e.g. high temperatures or plasma conditions) needed to react the precursors may damage other layers in the device structure. Also, CVD deposition methods often require complex chemistries which may result in the incorporation of impurity elements from the precursors into the deposited film. There is a need, therefore, for alternative methods of filling openings having small dimensions or high aspect ratios with active or conductive materials.

To address incomplete filling of openings, this invention sets forth a method in which the deposition of an active material or electrical contact material is followed by a step of increasing the surface mobility of the deposited material. Enhancement of surface mobility promotes the filling and densification of the active or contact material within an opening. The method reduces structural irregularities of materials formed in lithographic and sublithographic features, and promotes the uniform filling of openings with one or more desired materials. Improvements in the performance, reliability, design flexibility, and quality of the devices result.

### SUMMARY OF THE INVENTION

The instant invention provides electronic devices having logic, memory, switching, or processing functionality based on programmable resistance materials, switching materials or other active materials and methods of fabricating same.

In accordance with one embodiment of the instant invention, an electronic device includes a substrate with a plurality of stacked layers including a conducting bottom electrode layer, an insulative layer having an opening formed therein, and an active material layer deposited over both the insulative layer and the exposed bottom electrode layer.

In accordance with one embodiment of the instant invention, an active material is deposited within an opening of an insulator layer and is then subjected to an extrusion process. The extrusion process mobilizes the active material layer to cause it to move or flow and more completely fill the opening. As used herein, mobilize means to set in motion or increase the mobility of the active material or a contact material. Mobilization occurs, for example, when high pressure extrusion (or rapid thermal annealing) causes a stationary as-deposited active material layer to flow or otherwise alter its shape or position. The extruded active material layer covers the bottom electrode more uniformly and reduces the volume fraction of voids within the opening. The extruded active material layer thus includes a reduced concentration of structural irregularities and provides for more consistent and more reliable device characteristics.

In one embodiment, the extrusion process includes the step of subjecting the active material or contact material to an elevated background pressure following deposition. The elevated background pressure provides a mobilizing force that causes the active material to flow toward and into the opening to provide better filling and more uniform occupation of the opening. In a typical process, the active material is deposited in a deposition chamber that is sealed. An inert gas is then injected into the deposition chamber to elevate the background pressure to induce extrusion of the active material.

In another embodiment, the extrusion process includes the step of subjecting the active material or contact material to an elevated temperature following deposition. The elevated temperature provides a mobilizing force that causes the active material to flow toward and into the opening to provide better filling and more uniform occupation of the opening. In a typical process, the active material or contact material is deposited over an opening of a partially fabricated device and is heated to a softening point to facilitate reflow into or within the opening to better facilitate uniform filling. In one embodiment, reflow is achieved via a rapid thermal anneal (RTA) process. Extrusion may also be accomplished by combining high gas pressure and temperature.

For a better understanding of the instant invention, together with other and further illustrative objects thereof, reference is made to the following description, taken in conjunction with the accompanying drawings and claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic depiction of a conventional two-terminal electronic device having thickness non-uniformity and structural defects in the active layer.

FIG. 2 is a schematic depiction of a conventional two-terminal electronic device having thickness non-uniformity and structural defects in the active layer.

FIG. 3 illustrates a composite structure of an electronic device with an active material layer, such device having a conductive bottom electrode layer, an insulative layer with an opening, and active material that more uniformly fills an opening in the insulative layer.

FIG. 4 illustrates a partial cross-sectional view of an electronic device with an active material layer including a substrate and a first stacked conductive lower contact layer, and a second stacked insulative layer on the deposited conductive first stacked lower contact layer.

FIG. 5 is a schematic depiction of the electronic device illustrated in FIG. 4 having a lithographically formed opening within the insulative layer.

FIG. 6 illustrates a partial cross-sectional view of an electronic device with an active material layer deposited via a standard deposition process on the electronic device illustrated in FIG. 5.

FIG. 6A illustrates an electronic device in an intermediate state of fabrication with an active material layer exhibiting a “keyhole” structure.

FIG. 6B illustrates an electronic device in an intermediate state of fabrication with an active material layer exhibiting a multiple void structure.

FIG. 7 is a schematic depiction of coverage of the active material layer on the insulative layer and within the opening illustrated in FIG. 6 using high pressure extrusion and/or rapid thermal annealing methods in accordance with embodiments of the instant invention.

### DETAILED DESCRIPTION OF ILLUSTRATED EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

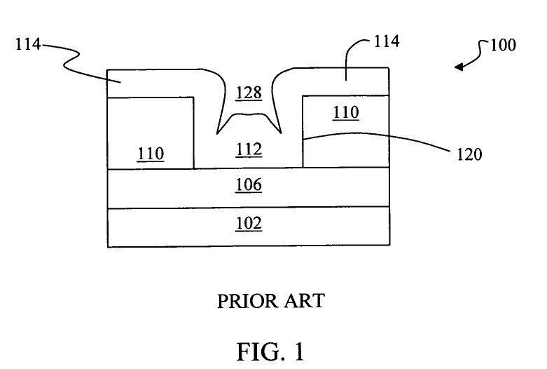

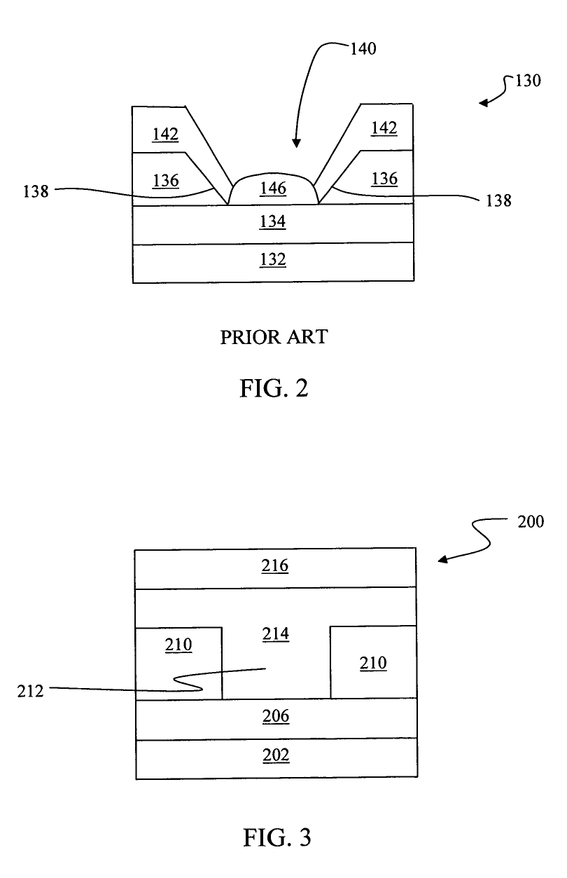

Various intermediate stages of manufacturing an electronic device including a step of filling an opening within an insulating material are illustrated in FIGS. 1 through 7. The figures include stages representative of the prior art and stages in accordance with the instant invention that highlight advantages of the methods described herein. Throughout the various views and illustrative embodiments of the instant invention, like reference numbers are used to designate like elements.

The instant invention improves the uniformity, coverage, and structural characteristics of active material layers deposited by conventional deposition processes. The benefits are particularly pronounced for non-conformal or line-of-sight deposition techniques and in device structures that require filling of high aspect ratio openings. The process of the instant invention may be included in the fabrication of 2- or 3-terminal active material device structures and may provide the filling and uniformity benefits referred to herein for openings having lateral dimensions approaching, at or below the limits of, photolithography or e-beam lithography. The instant methods apply to the filling of openings with active materials (including electronic materials, phase-change materials, chalcogenide materials, programmable resistance materials, and switching materials) and electrical contact materials (e.g. metals, metal alloys, heaters, metal nitrides).

FIG. 3 illustrates the structure of a representative electronic device 200 having an opening 212 occupied by active material 214. Device 200 includes substrate 202, which may be a silicon wafer or other substrate comprising a semiconductor or conductive material. Substrate 202 may further include access devices, transistors, diodes, power devices, drivers, sense amplifiers, interconnect lines, or other electronic circuitry. The stacked layers formed on substrate 202 typically include a conductive bottom electrode 206, an insulative layer 210 having an opening 212 formed therein to expose a portion of bottom electrode layer 206, an active material layer 214 formed within opening 212 and optionally on insulative layer 210, and a top electrode layer 216 formed over active material layer 214. To further reduce the contact area between active material layer 214 and bottom electrode 206, one may include insulative sidewall spacer layers (not shown) within opening 212 before depositing active material layer 214.

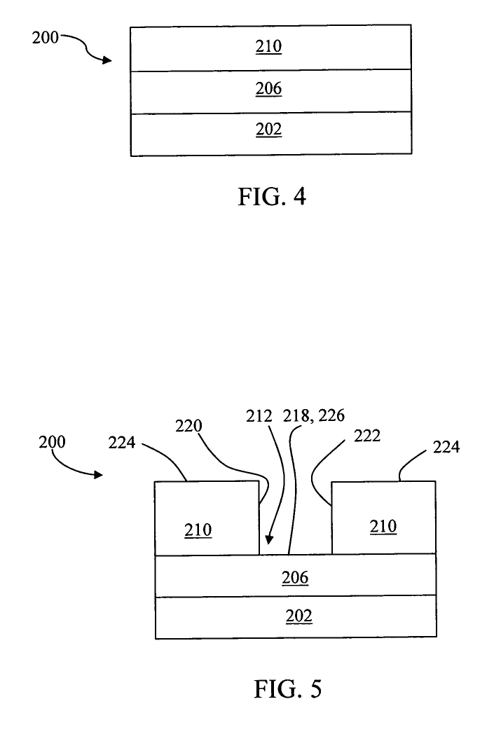

FIG. 4 shows a cross sectional view of the lower portion of electronic device 200 at an intermediate stage of fabrication. Bottom electrode layer 206 comprises a conductive material and is formed on substrate 202. In one embodiment, bottom electrode layer 206 includes or is connected to a conductive word line or bit line that may be used to deliver power from an external supply to electronic device 200. Materials that may be used to form bottom electrode layer 206 include Ti, TiW, W, TiAlN, TiSiN, Ta, TaN, Mo, MoN, TiN, C, Nb, Co, Ni, Re, or a combination of one or more of the foregoing materials. Bottom electrode layer 206 may be deposited via physical or chemical vapor deposition.

Insulative layer 210 is deposited on bottom electrode layer 206. The insulative layer 210 may comprise an oxide (e.g. silicon oxides (SiO₂, SiOₓ)), nitride (e.g. silicon nitrides (Si₃N₄, SiNₓ), or other dielectric material and may be formed using physical or chemical vapor deposition.

As shown in FIG. 5, insulative layer 210 includes opening 212 for receiving active material 214. Opening 212 is formed having a predefined depth, width, and shape. Representative openings include pores, vias, trenches, holes, or channels. The cross-section of opening 212 may be round (e.g. circular or elliptical), rectilinear (e.g. square or rectangle), or a combination of round and rectilinear. The openings may be formed in insulative layer 210 by patterning and etching. In a typical process, a photoresist is formed on insulative layer 210 and then masked to define the lateral dimensions of one or more openings. The unmasked portion of the photoresist is then removed to expose the top surface of insulative layer 210, which is subsequently etched to form one or more openings 212. Etching may be achieved through a wet chemical etch (e.g. hydrofluoric acid etch), a dry plasma etch (e.g. CHF₃+CF₄ plasma etch), or a reactive ion etch (e.g. CHF₃+CF₄ reactive ion etch). After etching, the masked photoresist is removed using conventional techniques. Photolithography or e-beam lithography may also be used to form opening 212. In a preferred embodiment, the depth of opening 212 extends for the thickness of insulative layer 210 to expose a portion 218 of the top surface of bottom electrode layer 206.

The size and shape of opening 212 are defined by sidewall 220, sidewall 222, and bottom surface 226. If the cross-section of opening 212 is an enclosed shape (e.g. circle or square), opening 212 will have a single continuous sidewall. If the cross-section of opening 212 is not an enclosed shape (e.g. trench), opening 212 will have two or more sidewalls. The sidewall surfaces of opening 212 extend from upper surface 224 of insulative layer 210 to selectively exposed portion 218 of bottom electrode layer 206.

In an embodiment of the invention, the width or lateral dimension of the opening 212 is at the lithographic limit. In another embodiment, the width or lateral dimension of the opening 212 is sublithographic. The lithographic limit is a feature size limit imposed by lithographic processing capabilities normally attributable to a practical limit on the wavelength of the light or beam column width of an electron beam source used to pattern or segment features during processing. According to the current technology roadmap, the feature size limit for flash technology is 65 nm (NOR)/57 nm (NAND). As processing techniques improve, the feature size limit will decrease in the future to further the goal of miniaturization. The projected feature size limit is 45 nm (NOR)/40 nm (NAND) in 2010 and 32 nm (NOR)/28 nm (NAND) in 2013. The extrusion method described herein for filling openings will scale with equal efficacy as the feature size limit decreases in the future.

In one embodiment, the width or lateral dimension of the opening 212 is generally the physical dimension of the opening in a direction parallel to the substrate 202. In FIG. 5, for example, the width or lateral dimension is the distance between sidewall 220 and sidewall 222. When the shape of the opening is round, the lateral dimension may be the diameter or the equivalent thereof of the opening.

The aspect ratio of the opening 212 may be defined as the ratio of the height or normal dimension of the opening to the width or lateral dimension of the opening. The height or normal dimension of the opening 212 is generally the physical dimension of the opening perpendicular to the substrate 202. In FIG. 5, for example, the height or normal dimension of the opening 212 corresponds to the thickness of insulative layer 210.

In one embodiment, the instant extrusion process is effective for improving the filling of an opening having an aspect ratio of greater than or equal to 0.25:1. In another embodiment, the instant extrusion process is effective for improving the filling of an opening having an aspect ratio of greater than or equal to 1:1. In another embodiment, the instant extrusion process is effective for improving the filling of an opening having an aspect ratio of greater than or equal to 3:1. In still another embodiment, the instant extrusion process is effective for improving the filling of an opening having an aspect ratio of greater than or equal to 5:1.

After opening 212 is formed in insulative layer 210, a layer of active material 214 is deposited. Deposition of active material 214 occurs over upper surface 224 of insulative layer 210, exposed portion 218 of bottom electrode 206, and within and along sidewalls 220 and 222 of opening 212.

Active material 214 is an electrically stimulable material and may include a phase change material, chalcogenide material, pnictide material, programmable resistance material, electrical switching material, other electronic material, or a combination thereof.

A programmable resistance material is a material having two or more states that are distinguishable on the basis of electrical resistance. The two or more states may be structural states, chemical states, electrical states, optical states, magnetic states, or a combination thereof. A programmable resistance material is transformable (“programmable”) between any pair of states by supplying an appropriate amount of energy to the material. The supplied energy may be referred to as a “programming energy”. When transformed (“programmed”) to a particular state, the programmable resistance material remains in that state until additional energy is supplied to the material. The different states of a programmable resistance material are stable in the absence of external energy and persist for an appreciable amount of time upon removal of the source of programming energy.

Phase change materials include materials that are transformable between two or more crystallographically-distinct structural states. The states may differ in crystal structure, unit cell geometry, unit cell dimensions, degree of disorder, particle size, grain size, or composition. Chalcogenide materials are materials that include an element from Column VI (e.g. S, Se, Te) of the periodic table as a significant or predominant component along with one or more modifying elements from Columns III (e.g. Al, Ga, In), IV (e.g. Ge, Si), or V (e.g. P, As, Sb) of the periodic table. Pnictide materials are materials that include an element from Column V of the periodic table as a significant component along with one or more modifying elements from Columns III, IV, or VI of the periodic table. Other multi-resistance state materials include metal-insulator-metal structures with thin film insulators. Programmable resistance materials may serve as the active material in memory devices, including non-volatile memory devices. Representative programmable resistance materials in accordance with the instant invention are described in U.S. Pat. Nos. 6,967,344; 6,969,867; 7,020,006; and references cited therein; all of which disclosures are incorporated by reference herein.

Chalcogenide materials have been previously utilized in data processing, optical, electrical material and switching applications and some representative compositions and properties have been discussed in U.S. Pat. Nos. 5,543,737; 5,694,146; 5,757,446; 5,166,758; 5,296,716; 5,534,711; 5,536,947; 5,596,522; 6,087,674; and 7,186,998; the disclosures of which are hereby incorporated in their entireties by reference herein, as well as in several journal articles including “Reversible Electrical Switching Phenomena in Disordered Structures”, Physical Review Letters, vol. 21, p. 1450 1453 (1968) by S. R. Ovshinsky “Amorphous Semiconductors for Switching, Material, and Imaging Applications”, IEEE Transactions on Electron Devices, vol. ED-20, p. 91 105 (1973) by S. R. Ovshinsky and H. Fritzsche; the disclosures of which are hereby incorporated by reference herein.

Electrical switching materials are materials that are switchable between two states that differ in electrical conductivity. The two states range in conductivity from the relatively resistive (e.g. comparable to a dielectric or semi-resistive material) to the relatively conductive (e.g. comparable to a metal or semiconductive material). Electrical switching materials generally have a quiescent or relaxed state, usually a relatively resistive state, in which they exist in the absence of electrical energy. When electrical energy is applied, the switching material transforms to a more conductive state and persists in that state for so long as it is subjected to a critical amount of energy from an external source. When the external energy decreases below the critical level, the switching material relaxes back to its quiescent state. Switching materials include OTS (Ovonic Threshold Switch) materials, negative differential resistance materials, and metal-insulator-metal structures. Electrical switching materials also include certain chalcogenide and pnictide compositions. Illustrative switching materials include those described in U.S. Pat. Nos. 6,967,344 and 6,969,867 incorporated by reference hereinabove.

In the typical prior art process, additional layers are deposited over active material 214 to complete the device structure. In FIG. 3, for example, top electrode 216 is formed directly over active material 214. In other processes, active material 214 may first be etched or subjected to chemical mechanical polishing (CMP) to remove portions situated on upper surface 224 before depositing top electrode 216. Additional processing typically includes formation of column lines or interconnects above top electrode 216.

In the instant invention, an extrusion step is included in the processing scheme after deposition of active layer 214. The extrusion step promotes the uniform filling of openings and minimizes the presence of voids within the opening. As described more fully hereinbelow, imperfections in the filling of openings are avoided or ameliorated by including the instant extrusion methods in the fabrication process.

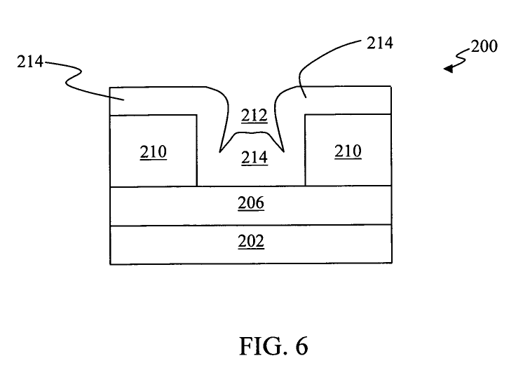

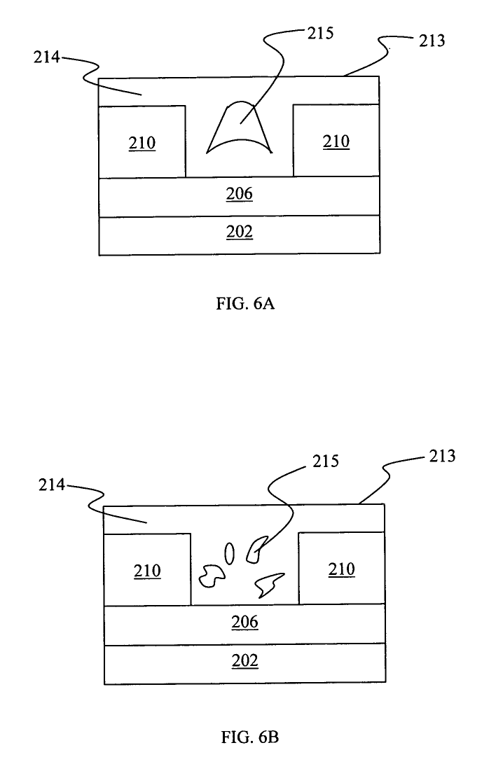

In an embodiment of the invention illustrated in FIG. 5, once the exposed portion 218 of the bottom electrode layer 206 is formed, the active material layer 214 is often deposited using a non-conformal deposition process such as physical vapor deposition, sputtering. The active material is deposited over the insulative layer 210, opening sidewalls 220, 222, and the exposed portion 218 of the bottom electrode layer 206. When a non-conformal deposition technique is used, filling of opening 212 becomes increasingly non-uniform and incomplete as the aspect ratio increases. In FIG. 6, for example, the thickness of active material layer 214 along sidewalls 220 and 222 varies in the direction normal to substrate 202. The greater thickness toward the upper surface 224 of insulative layer 210 occludes the internal unfilled portion of opening 212 and inhibits continuous, dense filling of opening 212. If the non-conformal deposition of active material layer 214 is continued beyond the state indicated in FIG. 6, an incompletely filled opening 212 may result. FIG. 6A, for example, illustrates a so-called “keyhole” structure that arises when the interior portion of opening 212 is fully occluded because of the variable thickness of active material layer 214. In the keyhole structure, active material layer 214 is continuous at its upper surface 213, but void 215 (an unfilled region) remains. In addition to keyhole structures, other structures with non-completely-filled openings 212 may form. Such structures may include a plurality of voids, which may be distributed uniformly or non-uniformly within opening 212. FIG. 6B shows one example of a structure having a plurality of voids 215.

The active material layer is typically deposited by a sputtering process well known in the art. Complete filling of openings is not critical in the initial deposition in the context of the instant invention because large voids can be ameliorated as described more fully hereinbelow.

The deposition temperature, pressure, and gas flows may be adjusted to tune the process deposition of the active (or contact) material during sputter deposition. Although conformal deposition (e.g. via CVD processing) may be beneficial, it is not necessary because filling the voids is not a requirement at this stage of processing in the context of the instant invention.

After the active material layer has initially been deposited on the insulative layer 210, within the opening 212, and on selected exposed portions of the bottom electrode 206, elevated gas pressure or thermal annealing may be used to increase the surface mobility of the active material.

In an embodiment of the invention, extrusion of the as-deposited active material is accomplished by subjecting the material to a high ambient gas pressure. The headspace of the deposition chamber above the deposition surface can be pressurized above atmospheric pressure to produce a force that biases the active material layer 214 to fill opening 212. A high external background pressure can induce flow of active material 214 in the structure of FIG. 6 into the unoccupied portion of opening 212. Similarly, a high external background pressure can induce the flow of active material 214 into voids 215 shown in FIGS. 6A and 6B to provide a denser fill of opening 212. Inert gases such as Ar, He, or N₂ may be used for external background gases in the instant pressure extrusion process. Once the opening filling process is complete, the pressure within the chamber may then be returned to atmospheric pressure and additional processing steps may next be undertaken.

The extrusion force provided by the elevated background pressure is expected to increase with increasing background pressure. In one embodiment, the background pressure is above 1 atmosphere. In another embodiment, the background pressure is above 5 atmospheres. In yet another embodiment, the background pressure is above 10 atmospheres. In still another embodiment, the background pressure is above 25 atmospheres. In a further embodiment, the background pressure is above 50 atmospheres.

The instant invention pressure extrusion method may also be performed at an elevated temperature. Heating of the active material can soften the material, thus reducing its viscosity and increasing its mobility. Beneficial mobility enhancements can occur through mild heating at temperatures well below the melting temperature of the material. Mild temperatures render the material less resistive to the extrusive effect induced by the elevated background pressure and promote the filling of openings and collapse of voids within openings. Voids, such as voids 215 shown in FIG. 6A and FIG. 6B, become more readily filled through flow of active material 214 while in a higher mobility state induced by high pressure extrusion with or without assistance from elevated temperatures.

In another aspect of the instant invention, reflow of the active material is achieved via thermal annealing. As indicated hereinabove, elevation of temperature aids in promoting the mobility of the active material and in the elimination of voids in the active material. A potential complication with the use of heat to promote reflow of the active material is a tendency for the active material to volatilize (e.g. evaporate or sublime) during the time period over which elevated temperatures are applied. Since most active materials are multicomponent materials, heating may lead to preferential volatilization of some elements relative to other elements and may thus lead to a modification of the active material composition. In addition, persistent elevated temperatures may damage surrounding layers of the device structure or facilitate undesired interdiffusion of atomic constituents between adjacent layers in the device structure. Persistent elevated temperatures may also induce chemical reactions, alloying, or decomposition of one or more layers of the structure.

One way to minimize the potential deleterious effects of temperature is to prevent overexposure of the active material or surrounding layers of the device structure to elevated temperatures. Effects such as diffusion, alloying, and chemical reaction entail atomic migrations. Atomic migrations are inhibited by energy barriers to motion that are overcome by subjecting a material to a sufficient amount of thermal energy for a sufficient amount of time. In this embodiment, the instant inventors reason that by limiting the time of exposure of the active material and its surrounding layers to elevated temperatures, the deleterious effects of atomic migration can be greatly reduced or avoided while still achieving the beneficial reflow effects achieved by thermal enhancement of mobility. Accordingly, a preferred embodiment of the instant invention entails subjecting the as-deposited active material to a rapid thermal annealing (RTA) process.

In rapid thermal annealing, the active material is exposed to a transient jump in temperature. The temperature is elevated to a temperature sufficient to soften the active material to induce flow, but the elevated temperature is terminated before appreciable atomic migration or thermally-induced reactions occur. Rapid thermal annealing is beneficial because the timescale needed to reflow the active material to fill openings and collapse the voids that appear in as-deposited material is shorter than the timescale needed for appreciable diffusion, alloying, reaction or decomposition. In a typical rapid thermal annealing process according to the instant invention, the active material is subjected to an elevated temperature for a time period of several seconds to several minutes. The precise time period is arrived at by balancing the thermal enhancement of mobility with the tendency of the active material to react or otherwise change composition. Factors such as the composition of the active material, compositions of surrounding insulator and contact materials, the presence of barriers layers in the device structure, and the chemical affinity of the active layer with surrounding layers ultimately control the time of exposure.

The instant invention further contemplates a rapid thermal annealing process that utilizes a sequence of thermal pulses to reflow the active material. Each of a series of thermal pulses can effect a partial reflow of the active material and can cumulatively achieve the goal of densely filling opening and eliminating voids. With a series of thermal pulses, the duration of any single pulse can be kept below the time threshold required for appreciable thermal degradation or modification of the active material while simultaneously providing sufficient thermal energy to partially reflow the active material. Complete reflow can be achieved by applying a sufficient number of thermal pulses.

In one embodiment, the active material is heated for a total of less than 10 minutes during the instant rapid thermal annealing process. In another embodiment, the active material is heated for a total of less than 3 minutes during the instant rapid thermal annealing process. In still another embodiment, the active material is heated for a total of less than 1 minute during the instant rapid thermal annealing process. In yet another embodiment, the active material is heated for a total of less than 30 seconds during the instant rapid thermal annealing process.

In one embodiment, the temperature induced by the thermal jump is a temperature sufficient to soften the active material. The softening temperature is normally a temperature well below the melting temperature of the active material, so rapid thermal annealing can be achieved at temperatures that minimize selective volatilization of elements within the composition of the active material. In one embodiment, the temperature of the active material during the instant rapid thermal annealing process is more than 100° C. below the melting point of the active material. In another embodiment, the temperature of the active material during the instant rapid thermal annealing process is more than 200° C. below the melting point of the active material. The cooling rate of the thermal pulse can also be controlled to avoid thermal stresses within the active material.

Rapid thermal annealing may be accomplished through any means of providing a transient temperature jump to a system known in the art. Energy sources such as heat lamps, resistive heaters, or lasers may be used to directly supply energy to the active material to heat it up. Alternatively, the substrate or chuck upon which the active material is deposited may be heated. Rapid thermal annealing may also be achieved by momentarily exposing the active layer to a hot surface facing the top surface of the active layer, where no physical contact occurs between the thermal surface and the active layer.

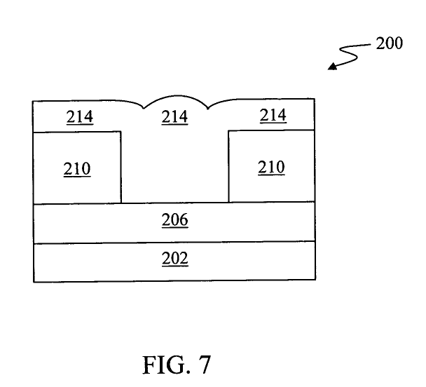

FIG. 7 depicts a schematic of a representative opening filled with active layer 214 in accordance with the instant invention using high pressure extrusion, rapid thermal annealing or a combination thereof. The active material layer 214 shown in FIG. 6 moves from the surface of insulative layer 210 into the opening 212 due to higher surface mobility and/or reduced viscosity induced by the instant high pressure extrusion or rapid thermal annealing steps. The thickness of active material layer 214 becomes thinner relative to its as-deposited state when the opening 212 fills more densely with the active material. Active material 214 occupies opening 212 in a dense, essentially void free fashion. The net result of the instant high pressure extrusion and rapid thermal annealing processes is a reduction in the volume fraction of voids and an increase in the volume fraction of active material 214 within opening 212 relative to the as-deposited state. Extrusion or reflow of active material 214 may similarly cause collapse of voids 215 shown in FIGS. 6A and 6B.

Once opening 212 is filled, a CMP (chemical-mechanical processing), RIE (reactive ion etching) or other planarization process may be used to remove the portion of active layer 214 remaining above the top surface of insulative layer 210. After the planarization process, the balance of the device 200 shown in FIG. 3 may be formed including sequential formation of a top electrode layer 216, which may be fabricated by conventional deposition techniques (e.g. sputtering or chemical vapor deposition).

The results have illustrated that with proper materials and use of temperature and pressure control methods, uniform coverage of the insulative layer with the active material layer and complete filling of the active material within the opening reduces structural irregularities within the opening thereby increasing material density, reducing thickness variations in the active material layer, reducing device shunting and early failure of the device, and improving device characteristics.

The disclosure and discussion set forth herein is illustrative and not intended to limit the practice of the instant invention. While there have been described what are believed to be the preferred embodiments of the instant invention, those skilled in the art will recognize that other and further changes and modifications may be made thereto without departing from the spirit of the invention, and it is intended to claim all such changes and modifications that fall within the full scope of the invention. It is the following claims, including all equivalents, in combination with the foregoing disclosure and knowledge commonly available to persons of skill in the art, which define the scope of the instant invention.

We claim:

1. A method of forming an electronic device comprising the steps of:
forming an active material over an insulating layer having an opening defined therein, said forming step occurring in a deposition environment having a first ambient pressure; and
increasing the pressure of said deposition environment to a second ambient pressure, said formed active material being exposed to said second ambient pressure, said second ambient pressure being sufficient to mobilize said formed active material.

2. The method of claim 1, wherein the depth of said opening is equal to the thickness of said insulative layer.

3. The method of claim 2, wherein said insulating layer is formed over a conductive layer, said opening exposing a top surface of said conductive layer.

4. The method of claim 3, wherein said active material contacts said exposed portion of said conductive layer.

5. The method of claim 1, wherein said active material is selected from the group consisting of programmable resistance materials, electronic switching materials, chalcogenide materials, phase-change materials, and pnictide materials.

6. The method of claim 5, wherein said active material comprises Te and Ge.

7. The method of claim 1, wherein said active material partially occupies said opening.

8. The method of claim 7, wherein said increasing pressure step increases the amount of said active material in said opening.

9. The method of claim 1, wherein said active material non-conformally contacts said insulative layer and a sidewall of said opening.

10. The method of claim 9, wherein said non-conformal active material includes one or more voids, at least one of said one or more voids occupying said opening.

11. The method of claim 10, wherein said increasing pressure step reduces the volume of said one or more voids occupying said opening.

12. The method of claim 11, wherein said increasing pressure step causes said active material to completely fill said opening.

13. The method of claim 12, wherein said opening has an aspect ratio of at least 0.25:1.

14. The method of claim 12, wherein said opening has an aspect ratio of at least 1:1.

15. The method of claim 12, wherein said opening has an aspect ratio of at least 3:1.

16. The method of claim 1, wherein said increasing pressure step is achieved by injecting an inert gas adjacent to said formed active material.

17. The method of claim 1, further comprising the step of heating said formed active material.

18. The method of claim 17, wherein said heating step provides sufficient heat to soften said formed active material.

19. The method of claim 18, wherein the amount of said provided heat is insufficient to thermally decompose or react said formed active material.

20. A method of forming an electronic device comprising the steps of:
forming an active material over an insulating layer having an opening defined therein; and
increasing the temperature of said formed active material, said increased temperature being sufficient to mobilize said formed active material.

21. The method of claim 20, wherein the depth of said opening is equal to the thickness of said insulative layer.

22. The method of claim 21, wherein said insulating layer is formed over a conductive layer, said opening exposing a top surface of said conductive layer.

23. The method of claim 22, wherein said active material contacts said exposed portion of said conductive layer.

24. The method of claim 20, wherein said active material is selected from the group consisting of programmable resistance materials, electronic switching materials, chalcogenide materials, phase-change materials, and pnictide materials.

25. The method of claim 24, wherein said active material comprises Te and Ge.

26. The method of claim 20, wherein said active material partially occupies said opening.

27. The method of claim 26, wherein said increasing temperature step increases the amount of said active material in said opening.

28. The method of claim 20, wherein said active material non-conformally contacts said insulative layer and a sidewall of said opening.

29. The method of claim 28, wherein said non-conformal active material includes one or more voids, at least one of said one or more voids occupying said opening.

30. The method of claim 29, wherein said increasing temperature step reduces the volume of said one or more voids occupying said opening.

31. The method of claim 30, wherein said increasing temperature step causes said active material to completely fill said opening.

32. The method of claim 31, wherein said opening has an aspect ratio of at least 0.25:1.

33. The method of claim 31, wherein said opening has an aspect ratio of at least 1:1.

34. The method of claim 31, wherein said opening has an aspect ratio of at least 3:1.

35. The method of claim 20, wherein the amount of said provided heat is insufficient to thermally decompose or react said formed active material.

36. The method of claim 20, wherein said active material is heated to a temperature of more than 100° C. below its melting temperature.

37. The method of claim 20, wherein said active material is heated for a time period of less than 10 minutes.

38. The method of claim 20, wherein said active material is heated for a time period of less than 3 minutes.

39. The method of claim 20, wherein said active material is heated for a time period of less than 1 minute.
